(19) United States
(12) Patent Application Publication
(10) Pub. No.: US 2025/0200833 A1
(43) Pub. Date: Jun. 19, 2025

(54) CONTROL APPARATUS AND NON-TRANSITORY COMPUTER READABLE MEDIUM

(71) Applicant: TOYOTA JIDOSHA KABUSHIKI KAISHA, Toyota-shi (JP)

(72) Inventors: Yuki TATSUMOTO, Seto-shi (JP); Takuya MAEKAWA, Kashiba-shi (JP); Hiroyasu SHIOKAWA, Nagoya-shi (JP); Shunsuke SAGARA, Nisshin-shi (JP); Makoto TAMURA, Miyoshi-shi (JP)

(73) Assignee: TOYOTA JIDOSHA KABUSHIKI KAISHA, Toyota-shi (JP)

(21) Appl. No.: 18/957,878

(22) Filed: Nov. 25, 2024

(30) Foreign Application Priority Data
Dec. 13, 2023 (JP) 2023-210357

(51) Int. Cl. G06T 11/00

(52) U.S. Cl. CPC G06T 11/001

(57) ABSTRACT

A control apparatus includes a communication interface configured to communicate with a terminal apparatus of a user, and a controller configured to acquire progress data indicating progress of production of a vehicle ordered by the user, set a growth level of a character according to the progress indicated by the acquired progress data, and transmit an image of the character that is to change depending on the growth level to the terminal apparatus via the communication interface.

### CROSS-REFERENCE TO RELATED APPLICATION

This application claims priority to Japanese Patent Application No. 2023-210357, filed on Dec. 13, 2023, the entire contents of which are incorporated herein by reference.

### TECHNICAL FIELD

The present disclosure relates to a control apparatus and a non-transitory computer readable medium.

### BACKGROUND

Patent Literature (PTL) 1 discloses an information provision apparatus that provides a user with information on the progress of a particular vehicle until delivery. This apparatus provides a user terminal with, for example, captured images during assembly or positional information during transport.

### CITATION LIST

### Patent Literature

PTL 1: JP 2002-297954 A

### SUMMARY

The conventional apparatus does not provide sufficient entertainment value for the service provided to customers waiting for delivery of their vehicles.

It would be helpful to provide a highly entertaining service to customers waiting for delivery of their vehicles to thereby reducing the stress of waiting for delivery.

A control apparatus according to the present disclosure includes:
a communication interface configured to communicate with a terminal apparatus of a user; and
a controller configured to:
   acquire progress data indicating progress of production of a vehicle ordered by the user;
   set a growth level of a character according to the progress indicated by the acquired progress data; and
   transmit an image of the character that is to change depending on the growth level to the terminal apparatus via the communication interface.

A non-transitory computer readable medium according to the present disclosure stores a program configured to cause a computer to execute operations, the operations including:
acquiring progress data indicating progress of production of a vehicle ordered by a user;
setting a growth level of a character according to the progress indicated by the acquired progress data; and
displaying an image of the character that is to change depending on the growth level.

According to the present disclosure, by providing a highly entertaining service to customers waiting for delivery of their vehicles, the stress of waiting for delivery may be reduced.

### BRIEF DESCRIPTION OF THE DRAWINGS

In the accompanying drawings:

FIG. 1 is a diagram illustrating a configuration of a system according to an embodiment of the present disclosure;

FIG. 2 is a diagram illustrating an example of a plurality of processes according to the embodiment of the present disclosure;

FIG. 3 is a block diagram illustrating a configuration of a control apparatus according to the embodiment of the present disclosure; and

FIG. 4 is a flowchart illustrating operations of the control apparatus according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

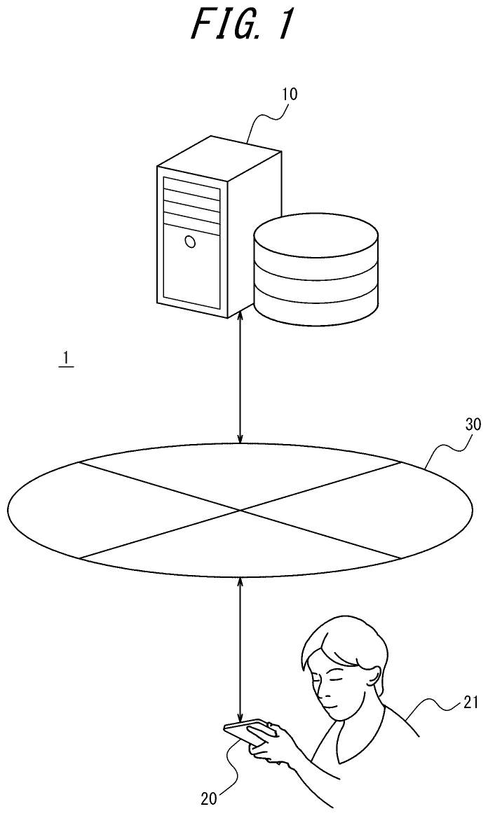

A configuration of a system 1 according to the present embodiment will be described with reference to FIG. 1.

The system 1 according to the present embodiment includes a control apparatus 10 and a terminal apparatus 20. The control apparatus 10 can communicate with the terminal apparatus 20 via a network 30.

The control apparatus 10 is a server computer such as a cloud server in the present embodiment, but it may be a general purpose computer such as a PC, a microcomputer in a mobile device such as a smartphone or tablet, or a dedicated computer. The term “PC” is an abbreviation of personal computer. In the present embodiment, the control apparatus 10 is operated by the vehicle production operator. The control apparatus 10 may be integrated with the terminal apparatus 20, for example, it may be a microcomputer mounted on the terminal apparatus 20.

The terminal apparatus 20 is a computer capable of installing and executing application programs, such as a PC mobile phone, smartphone, or tablet. The terminal apparatus 20 is used by a user 21.

The network 30 includes the Internet, at least one WAN, at least one MAN, or any combination thereof. The term “WAN” is an abbreviation of wide area network. The term “MAN” is an abbreviation of metropolitan area network. The network 30 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

In the present embodiment, the control apparatus 10 communicates with the terminal apparatus 20 of the user 21. The control apparatus 10 acquires progress data indicating the progress of production of a vehicle F ordered by the user 21. The control apparatus 10 sets a growth level of a character according to the progress indicated by the acquired progress data. The control apparatus 10 transmits an image of the character that is to change depending on the set growth level to the terminal apparatus 20 of the user 21. The terminal apparatus 20 receives the image of the character from the control apparatus 10. The terminal apparatus 20 displays the received image. This allows the user 21 to enjoy the growth of the character while waiting for the delivery of the vehicle F.

According to the present embodiment, by providing a highly entertaining service to the user 21 waiting for vehicle delivery, the stress of waiting for delivery may be reduced.

In the present embodiment, the user 21 is the purchaser who has ordered the vehicle F and is waiting for delivery. When the user 21 orders the vehicle F, a user ID is given to the user 21 to identify the purchaser. In addition, the vehicle F is assigned a VIN to identify the vehicle F. The term “ID” is an abbreviation of identifier. The term “VIN” is an abbreviation of Vehicle Identification Number. In the present embodiment, the user ID and VIN are tied to each other and stored in the control apparatus 10. The user ID and VIN may be stored in an external storage device.

In the present embodiment, the vehicle production operator uses a dedicated server to centrally manage the progress of production of the vehicle F. Dedicated servers can be cloud servers or on-premise servers installed at the vehicle manufacturer's facilities, such as factories. The progress data is data that indicates, as the progress of the production of the vehicle F, the process to which the vehicle F is currently engaged among the plurality of processes included in the production of the vehicle F, as well as the date and time when the process was started. When a tag reader installed on a line corresponding to a certain process in a factory, for example, reads a tag with a VIN attached to a vehicle F at the timing when the process starts, the dedicated server records data indicating the process and the date and time when the vehicle F was engaged in the process as progress data. The progress data is transmitted from the dedicated server to the control apparatus 10.

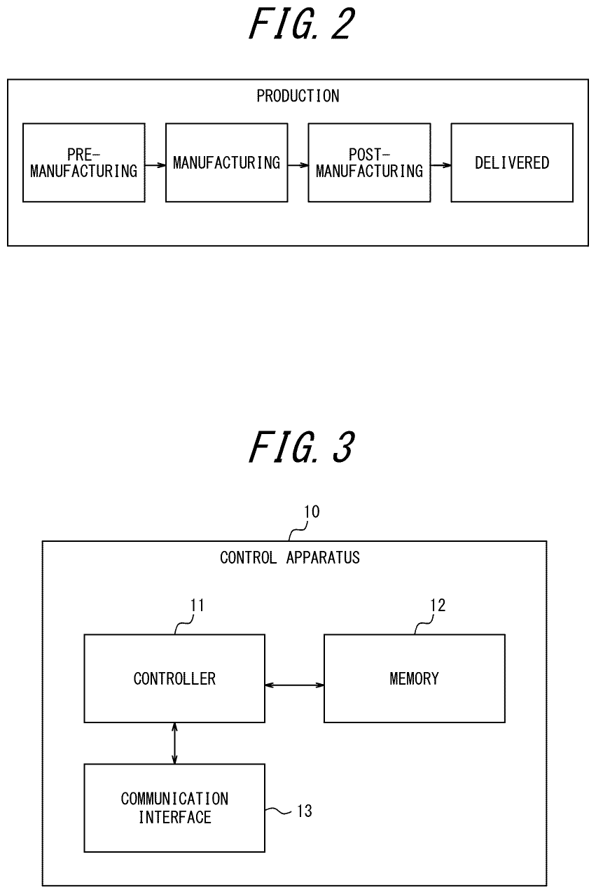

An example of the plurality of processes included in the production of a vehicle F is illustrated in FIG. 2. The production of the vehicle F includes four processes: a pre-manufacturing process, a manufacturing process, a post-manufacturing process, and a delivered process. The manufacturing process includes the sub-processes of stamping, painting, and assembly. The pre-manufacturing process is the process from the time the user 21 orders the vehicle F until before manufacturing begins at the factory. The manufacturing process is the process during which the vehicle F is being manufactured at the factory. The post-manufacturing process is the process that occurs after the vehicle F has been manufactured and before it is delivered to the user 21. The delivered process is the process after the vehicle F has been delivered to the user 21. The vehicle F proceeds through these processes in sequence.

As an example, first, a VIN of “1104” is assigned to a vehicle F. At this point, the progress data indicates the pre-manufacturing process. Next, when manufacturing of the vehicle F starts at the factory, the progress data indicates the process in progress. When the manufacturing of the vehicle F is completed, the progress data indicates the post-manufacturing process. Finally, when the vehicle F is delivered to the user 21, the progress data indicates a delivered process.

In the present embodiment, the service according to the present disclosure is provided to the user 21 according to progress. The service according to the present disclosure is a service that provides images of the character to the user 21. The “character image” is an image containing a character that changes according to a growth level set according to the progress of production of the vehicle F. The character may be predetermined or selected from several by the user 21. The “growth level” is the degree of growth of the character in the image displayed on the terminal apparatus 20 of the user 21. The growth level is set to an initial value of 0 when the vehicle F is ordered. As the process of the vehicle F production progresses, the value of the growth level increases. The more the value of the growth level increases, the more the character grows.

A configuration of the control apparatus 10 according to the present embodiment will be described with reference to FIG. 3.

The control apparatus 10 includes a controller 11, a memory 12, and a communication interface 13.

The controller 11 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 11 executes processes related to operations of the control apparatus 10 while controlling components of the control apparatus 10.

The memory 12 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 12 functions as, for example, a main memory, an auxiliary memory, or a cache memory. The memory 12 stores data to be used for the operations of the control apparatus 10 and data obtained by the operations of the control apparatus 10. In the present embodiment, the user ID of the user 21, the VIN “1104” of the vehicle F, and the progress data of the vehicle F are stored.

The communication interface 13 includes at least one communication module. The communication module is, for example, a module compatible with a wired LAN communication standard such as Ethernet® (Ethernet is a registered trademark in Japan, other countries, or both), a wireless LAN communication standard such as IEEE802.11, or a mobile communication standard such as LTE, the 4G standard, or the 5G standard. The name “IEEE” is an abbreviation of Institute of Electrical and Electronics Engineers. The term “LTE” is an abbreviation of Long Term Evolution. The term “4G” is an abbreviation of 4th generation. The term “5G” is an abbreviation of 5th generation. The communication interface 13 communicates with the terminal apparatus 20 via the network 30. The communication interface 13 receives data to be used for the operations of the control apparatus 10, and transmits data obtained by the operations of the control apparatus 10.

The functions of the control apparatus 10 are realized by execution of a program according to the present embodiment by a processor serving as the controller 11. That is, the functions of the control apparatus 10 are realized by software. The program causes a computer to execute the operations of the control apparatus 10, thereby causing the computer to function as the control apparatus 10. That is, the computer executes the operations of the control apparatus 10 in accordance with the program to thereby function as the control apparatus 10.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Some or all of the functions of the control apparatus 10 may be realized by a programmable circuit or a dedicated circuit serving as the controller 11. That is, some or all of the functions of the control apparatus 10 may be realized by hardware.

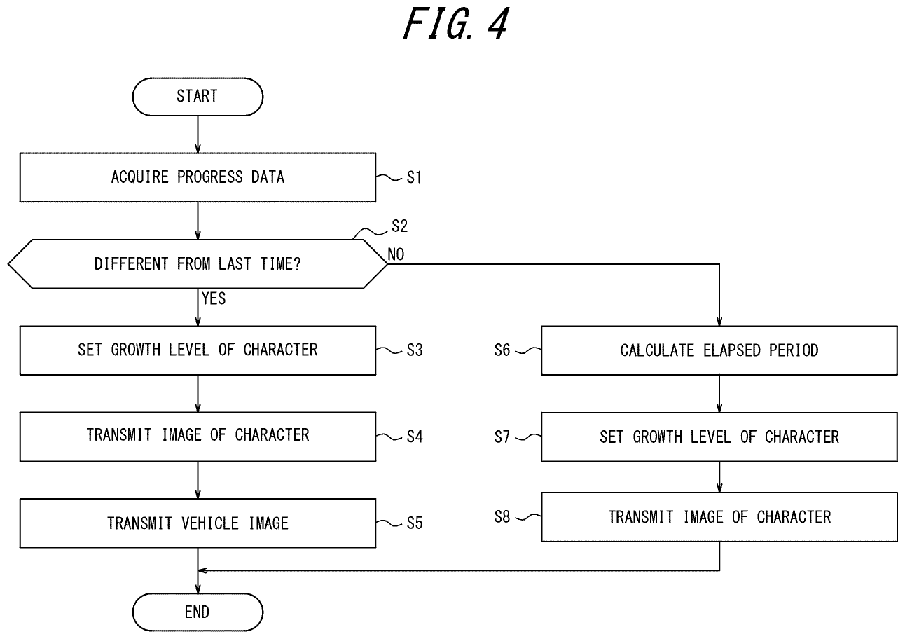

Operations of the control apparatus 10 according to the present embodiment will be described with reference to FIG. 4. The operations described below correspond to a control method according to the present embodiment. In other words, the control method according to the present embodiment includes steps S1 to S8 illustrated in FIG. 4.

Once the user ID is assigned to the user 21 who ordered the vehicle F and the VIN is assigned to the vehicle F, step S1 is initiated. After the flow illustrated in FIG. 4 is completed, step S1 is initiated when a predetermined period has elapsed, such as a day, or at any other predetermined timing.

In S1, the controller 11 acquires the progress data. Specifically, the controller 11 acquires the progress data from the dedicated server via the communication interface 13. In the present embodiment, the progress data acquired in S1 indicates one of the four processes of FIG. 2. The progress data acquired in S1 indicates the date and time when the process was started.

In S2, the controller 11 determines whether the progress data acquired in S1 is different from the progress data already stored in the memory 12. Specifically, the controller 11 determines whether the process indicated by the progress data acquired in S1 is different from the process already stored in the memory 12, i.e., the process indicated by the progress data acquired last time. If it is determined that the process indicated by the progress data acquired in S1 is different from the process indicated by the progress data already stored in the memory 12, the processing proceeds to S3. The controller 11 updates the progress data already stored in the memory 12 with the progress data acquired in S1 just before S3. If there is no progress data already stored in the memory 12, i.e., if step S1 is performed for the first time for the vehicle F, the processing also proceeds to S3. The controller 11 stores the progress data acquired in S1 in the memory 12 immediately before S3. If it is determined that the process indicated by the progress data acquired in S1 is the same as the process indicated by the progress data already stored in the memory 12, the processing proceeds to S6. For example, if, in the production of the vehicle F, the progress data already stored in the memory 12 indicates the pre-manufacturing process, and the progress data acquired in S1 indicates the manufacturing process, the processing proceeds to S3. On the other hand, if the progress data already stored in the memory 12 indicates a pre-manufacturing process and the progress data acquired in S1 also indicates a pre-manufacturing process, the processing proceeds to S6.

In S3, the controller 11 sets the growth level of the character according to the progress indicated by the progress data acquired in S1. Specifically, the controller 11 sets the growth level of the character to the initial value if the current process of the vehicle F, as indicated by the progress data acquired in S1, is the first process among the plurality of processes included in the production of the vehicle F. The controller 11 stores the data indicating the set growth level in the memory 12 as growth level data. If the current process of the vehicle F, as indicated by the progress data acquired in S1, is the second process among the plurality of processes included in the production of the vehicle F, the controller 11 sets the growth level of the character to the initial value plus a predetermined value. The controller 11 updates the growth data stored in the memory 12 with data indicating the set growth level. When N is an integer greater than or equal to 2, and the current process of the vehicle F indicated by the progress data acquired in S1 is the N+1st process among the plurality of processes included in the production of the vehicle F, the controller 11 sets the growth level of the character to the value corresponding to the Nth process plus a predetermined value. The controller 11 updates the growth data stored in the memory 12 with data indicating the set growth level. In the present embodiment, the growth level at the time the vehicle F is ordered is set to the initial value of 0. The predetermined value to be added is 100. Thus, as the process of the vehicle F progresses, the growth level increases to 100, 200, 300, and so on. For example, if the progress data acquired in S1 indicates a manufacturing process, the controller 11 sets the growth level to 100. For example, if the progress data acquired in S1 indicates a post-manufacturing process, the controller 11 sets the growth level to 200. For example, if the progress data acquired in S1 indicates a delivered process, the controller 11 sets the growth level to 300.

In S4, the controller 11 transmits the image of the character that is to change depending on the growth level set in S3 to the terminal apparatus 20 via the communication interface 13. Specifically, the controller 11 generates an image in which the character is in the first stage of growth if the growth level set in S3 is the initial value. If the growth level set in S3 is the value corresponding to the Nth process, the controller 11 generates an image in which the character is in the Nth stage of growth. The controller 11 transmits the generated image to the terminal apparatus 20 via the communication interface 13. Characters can be real or imaginary, such as humans, animals, or plants, as long as they grow. As an example, when the character is a monster, the first stage of growth may be the egg stage, the second stage the juvenile stage, the third stage the adult stage, and the fourth stage the departure stage. Departure” means moving away from the place where the character was born and raised, such as a nest or home. For example, if the growth level set in S3 is 0, the controller 11 generates an image of an egg as the image of the character. For example, if the growth level set in S3 is 100, the controller 11 generates an image of a juvenile beast as the image of the character. For example, if the growth level set in S3 is 200, the controller 11 generates an image of an adult animal as the image of the character. For example, if the growth level set in S3 is 300, the controller 11 generates an image of an adult animal on a journey as the image of the character. As another example, when the character is human, the first stage of growth may be the child stage, the second stage the adolescent stage, the third stage the departure stage, and the fourth stage the battle stage. For example, if the growth level set in S3 is 0, the controller 11 generates an image of a child as the image of the character. For example, if the growth level set in S3 is 100, the controller 11 generates an image of a young man as the image of the character. For example, if the growth level set in S3 is 200, the controller 11 generates an image of a young man going on a journey as the image of the character. For example, if the growth level set in S3 is 300, the controller 11 generates an image of a young man fighting a monster as the image of the character. Receiving and displaying images of the character by the terminal apparatus 20 can further enhance the entertainment value of the service provided to the user 21.

In S5, the controller 11 transmits the vehicle image of the vehicle F to the terminal apparatus 20 via the communication interface 13 according to the progress indicated by the progress data acquired in S1. The vehicle image is an image of the vehicle F taken at each process in the production of the vehicle F. Vehicle images are captured by cameras installed at the plant and stored on a dedicated server. There may be more than one vehicle image. Specifically, if the current process of the vehicle F indicated by the progress data acquired in S1 is the first process among the plurality of processes included in the production of the vehicle F, the controller 11 acquires the vehicle image taken in the first process from the dedicated server via the communication interface 13. If the current process of the vehicle F indicated by the progress data acquired in S1 is the Nth process among the plurality of processes included in the production of the vehicle F, the controller 11 acquires the vehicle image taken at the Nth process via the communication interface 13. The controller 11 transmits the acquired vehicle image to the terminal apparatus 20 via the communication interface 13. However, after the vehicle F is delivered, the controller 11 does not perform step S5. As an example, if the progress data acquired in S1 indicates a pre-manufacturing process, the controller 11 transmits the vehicle images taken in the pre-manufacturing process to the terminal apparatus 20 via the communication interface 13. The vehicle image taken during the pre-manufacturing process is, for example, an image of the material used in the manufacture of the vehicle F. If the progress data acquired in S1 indicates a manufacturing process, the controller 11 transmits the vehicle images taken during the manufacturing process to the terminal apparatus 20 via the communication interface 13. The vehicle image taken during the manufacturing process is, for example, an image of the vehicle F as it passes through the three sub-processes of stamping, painting, and assembly. If the progress data acquired in S1 indicates a post-manufacturing process, the controller 11 transmits the vehicle images taken in the post-manufacturing process to the terminal apparatus 20 via the communication interface 13. The vehicle images taken during the post-manufacturing process are, for example, images taken of the vehicle F during vehicle option installation or images taken of the vehicle F at the delivery location. If the progress data acquired in S1 indicates a delivered process, the controller 11 does not perform step S5. The vehicle image is received and displayed by the terminal apparatus 20, allowing the user 21 to see the actual production status of the vehicle F.

After S5, the flow illustrated in FIG. 4 ends.

In S6, the controller 11 calculates the elapsed period. The “elapsed period” is the number of days from the date when the current process was started to the date when the progress data was acquired in S1. Specifically, the controller 11 acquires data from the memory 12 that indicates the date and time when the current process was started, which is included in the progress data. The controller 11 calculates the elapsed period as the number of days from the date when the current process was started to the date when the progress data was acquired in S1, as indicated by the acquired data. For example, if the current pre-manufacturing process started on Feb. 19, 2023, and the date the progress data was acquired in S1 is Mar. 15, 2023, the controller 11 calculates that the elapsed period is 24 days.

In S7, the controller 11 sets the growth level after each predetermined period, even during a period in which there is no change in the progress indicated by the progress data acquired in S1. Specifically, when the elapsed period calculated in S6 equals an integer multiple of the predetermined period, the controller 11 sets the growth level of the character to the value stored in the memory 12 plus the predetermined value. However, if the value after addition is greater than or equal to the growth level set in the next process, the controller 11 does not add the predetermined value. The predetermined period may be different for each process. As an example, the predetermined period is 30 days for the pre-manufacturing process, 1 day for the manufacturing process, and 2 days for the post-manufacturing process. The predetermined value is 10. For example, if the progress data acquired in S1 indicates a pre-manufacturing process and the elapsed period calculated in S6 is 29 days, the controller 11 leaves the growth level at 0. When the progress data acquired in S1 indicates the pre-manufacturing process and the elapsed period calculated in S6 is 30 days, the elapsed period is equal to one times the predetermined period of 30 days, and the controller 11 sets the growth level to 10. When the elapsed period calculated in S6 is 60 days, the elapsed period equals twice the predetermined period of 30 days, and the controller 11 sets the growth level to 20. However, even if the elapsed period calculated in S6 equals an integral multiple of 30 days in the pre-manufacturing process, the controller 11 does not add the growth level to 100 or more. For example, if the progress data acquired in S1 indicates a manufacturing process and the elapsed period calculated in S6 is 1 day, the controller 11 sets the growth level of the character to 110. For example, if the progress data acquired in S1 indicates a post-manufacturing process and the elapsed period calculated in S6 is 1 day, the controller 11 leaves the growth level at 200. If the progress data acquired in S1 indicates a post-manufacturing process and the elapsed period calculated in S6 is 2 days, the controller 11 sets the growth level of the character to 210.

In S8, the controller 11 transmits an image of the same character as the image transmitted in S4, which is to change depending on the growth level set in S7, to the terminal apparatus 20 via the communication interface 13. Specifically, if the growth level set in S7 is between the initial value and the value corresponding to the second process, the controller 11 generates an image in which the growth of the character is slightly advanced in the first stage. If the growth level set in S7 is between the value corresponding to the Nth process and the value corresponding to the N+1th process, the controller 11 generates an image in which the character growth is slightly advanced in the Nth step. The controller 11 transmits the generated image to the terminal apparatus 20 via the communication interface 13. For example, if the growth level set in S7 is 10, the controller 11 generates an image of the character with one crack in the eggshell. For example, if the growth level set in S7 is 20, the controller 11 generates an image of the character with two cracks in the eggshell or one crack in the eggshell that has grown slightly larger. For example, if the growth level set in S7 is 110, the controller 11 generates an image of the character as a juvenile beast that has grown a little larger, e.g., from a baby to a child. For example, if the growth level set in S7 is 210, the controller 11 transmits an image of a slightly larger adult animal as the character image. By advancing the growth of the character after each certain period, even during a period in which there is no change in the progress of the production of the vehicle F, the stress of waiting for delivery can be reduced for the user 21 when there is a delay in the production of the vehicle F.

After S8, the flow illustrated in FIG. 4 ends.

As described above, in S1 through S8, the controller 11 acquires progress data indicating the progress of production of the vehicle F ordered by the user 21. The controller 11 sets the growth level of the character according to the progress indicated by the acquired progress data. The controller 11 transmits an image of the character that is to change depending on the set growth level to the terminal apparatus 20 of the user 21. The terminal apparatus 20 displays the received image. This allows the user 21 to enjoy the growth of the character while waiting for the delivery of the vehicle F.

According to the present embodiment, by providing a highly entertaining service to the user 21 waiting for vehicle delivery, the stress of waiting for delivery may be reduced.

As a variation of the present embodiment, the controller 11 may acquire color data indicating the body color of the vehicle F. Upon completion of painting, the controller 11 may change the color of the character in the image of the character to a color corresponding to the body color indicated by the acquired color data. The color data is stored in advance, for example, on a dedicated server. The progress data further indicates the sub-processes to which the vehicle F is currently engaged, if the process to which the vehicle F is currently engaged is a manufacturing process. In S2, the controller 11 determines that painting has been completed when the progress data acquired in S1 indicates the sub-process of assembly, which is the next sub-process after coating. When the sub-process proceeds from painting to assembly, the process remains in the manufacturing, so the processing proceeds from S2 to S6, S7, and S8. In S8, the controller 11 acquires color data from the dedicated server via the communication interface 13. The controller 11 generates an image of the character in which the color of the character is changed to a color corresponding to the body color indicated by the acquired color data. The controller 11 transmits the generated image to the terminal apparatus 20 via the communication interface 13. For example, when the controller 11 recognizes that the sub-process has changed from painting to assembly as indicated by the progress data acquired in S1, it acquires data indicating the body color “silver” of the vehicle F from the dedicated server via the communication interface 13. If the growth level set in S7 is 110, the controller 11 generates an image in which the color of at least part of the body of the slightly larger, e.g., baby to child, juvenile animal is changed to silver. The controller 11 transmits the generated image to the terminal apparatus 20 via the communication interface 13. By changing the color of the character to match the timing of the change in the body color of the vehicle F, the entertainment value of the service provided to the user 21 can be further enhanced. The color of the character may be changed to the same color as the body color of the vehicle F, or to a color similar to the body color of the vehicle F.

As another variation of the present embodiment, the production of the vehicle F may include option installation. The controller 11 may further acquire vehicle option data indicating one or more vehicle options ordered by the user 21. Upon completion of the option installation, the controller 11 may transmit an image of the character wearing the item corresponding to the vehicle option indicated by the acquired vehicle option data as an image of the character. Vehicle option data is stored in advance, for example, on a dedicated server. The progress data further indicates whether or not the installation on the vehicle F is complete for each vehicle option ordered by the user 21. In S4 or S8, the controller 11 acquires vehicle option data from the dedicated server via the communication interface 13. The controller 11 determines, from the progress data acquired in S1, which of the vehicle options indicated by the acquired vehicle option data has completed the option installation. The controller 11 generates an image of the character wearing the item corresponding to the determined vehicle option as the image of the character. The controller 11 transmits the generated image to the terminal apparatus 20 via the communication interface 13. As an example, assume that the vehicle options ordered by the user 21 are a factory navigation system and an ETC in-vehicle device, and that the option installation of the factory navigation system is included in the manufacturing process and the option installation of the ETC in-vehicle device is included in the post-manufacturing process. The “ETC” is an abbreviation of electronic toll collection system. For example, if the progress data acquired in S1 indicates a process in manufacturing, the controller 11 recognizes from the progress data that the installation of the genuine navigation system is complete, and generates an image of the juvenile beast wearing a sword as an item corresponding to the genuine navigation system. The controller 11 transmits the generated image to the terminal apparatus 20 via the communication interface 13. For example, if the progress data acquired in S1 indicates a post-manufacturing process, when the controller 11 recognizes from the progress data that the installation of the ETC in-vehicle device has been completed, it generates an image of an adult animal wearing a shield as an item corresponding to the ETC in-vehicle device in addition to a sword, an item corresponding to a genuine navigation system. The controller 11 transmits the generated image to the terminal apparatus 20 via the communication interface 13. By having the character wear the item in accordance with the timing of when the vehicle F is equipped with options, the entertainment value of the service provided to the user 21 can be further enhanced.

As yet another variation of the present embodiment, the controller 11 may transmit additional option data to the terminal apparatus 20 indicating additional vehicle options that can be ordered by the user 21 according to the progress indicated by the progress data. For example, if the progress data acquired in S1 indicates the first process, the controller 11 transmits data indicating unordered vehicle options that can be installed after the second process to the terminal apparatus 20 via the communication interface 13 as additional option data. When the progress data acquired in S1 indicates the Nth process, the controller 11 transmits data indicating unordered vehicle options that can be installed after the N+1st process to the terminal apparatus 20 via the communication interface 13 as additional option data. If there are no unordered vehicle options that can be installed after the N+1st process, the controller 11 may transmit a message to the terminal apparatus 20 via the communication interface 13 as additional option data, indicating that there are no vehicle options that can be added. As an example, suppose that the user 21 can order additional vehicle options for body parts and floor mats after ordering the vehicle F. Since body parts are constructed during the manufacturing process, additional orders can be placed during the pre-manufacturing process. In addition, floor mats are installed in the post-manufacturing process, so additional orders can be placed during the pre-manufacturing and manufacturing processes. For example, if the progress data acquired in S1 indicates a pre-manufacturing process, the controller 11 transmits data indicating body parts and floor mats to the terminal apparatus 20 via the communication interface 13 as additional option data. For example, if the progress data acquired in S1 indicates a manufacturing process, the controller 11 transmits data indicating floor mats to the terminal apparatus 20 via the communication interface 13 as additional option data. For example, if the progress data acquired in S1 indicates a post-manufacturing process, the controller 11 transmits a message such as “Vehicle options cannot be ordered” to the terminal apparatus 20 via the communication interface 13 as a message indicating that there are no additional vehicle options that the user 21 can order. Displaying the vehicle option data received by the terminal apparatus 20 makes it easier for the user 21 to order additional vehicle options.

As yet another variation of the present embodiment, the controller 11 may transmit the image of the character to the vehicle F upon completion of the delivery. Specifically, if the progress data acquired in S1 indicates a delivered process, the controller 11 may determine that the delivery has been completed and transmit the image generated in S4 to the vehicle F via the communication interface 13. The vehicle F may display this image on the multimedia screen of the vehicle F. By displaying the image of the grown-up character on the screen of the vehicle F, it is possible to make the user 21 feel attached to the vehicle F immediately after delivery.

As yet another variation of the present embodiment, the controller 11 may further transmit images of characters to servers controlling other games via the communication interface 13. The controller 11 may further transmit vehicle option data indicating the vehicle options ordered by the user 21, and the character may be strengthened by the vehicle options indicated by the vehicle option data. The character is, for example, a horse. For example, the controller 11 may transmit an image of a grown horse to a server that controls a game that raises competitive horses, so that the grown horse can participate in races. For example, the controller 11 may further transmit vehicle option data indicating the “engine starter function”, a vehicle option ordered by the user 21, which may make the horse even faster. This can further enhance the entertainment value for the service.

The present disclosure is not limited to the embodiment described above. For example, two or more blocks described in the block diagram may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

1. A control apparatus comprising:
a communication interface configured to communicate with a terminal apparatus of a user; and
a controller configured to:
acquire progress data indicating progress of production of a vehicle ordered by the user;
set a growth level of a character according to the progress indicated by the acquired progress data; and
transmit an image of the character that is to change depending on the growth level to the terminal apparatus via the communication interface.

2. The control apparatus according to claim 1, wherein the controller is configured to set the growth level after each predetermined period, even during a period in which there is no change in the progress.

3. The control apparatus according to claim 1,
wherein the production of the vehicle includes painting, and
the controller is configured to:
acquire color data indicating a body color of the vehicle; and
change, upon completion of the painting, a color of the character in the image to a color corresponding to the body color indicated by the acquired color data.

4. The control apparatus according to claim 1,
wherein the production of the vehicle includes option installation, and
the controller is configured to:
further acquire vehicle option data indicating a vehicle option ordered by the user; and
transmit, upon completion of the option installation, an image of the character wearing an item corresponding to the vehicle option indicated by the acquired vehicle option data as the image of the character.

5. A non-transitory computer readable medium storing a program configured to cause a computer to execute operations, the operations comprising:
acquiring progress data indicating progress of production of a vehicle ordered by a user;
setting a growth level of a character according to the progress indicated by the acquired progress data; and
displaying an image of the character that is to change depending on the growth level.
